(19) United States
(12) Patent Application Publication
(10) Pub. No.: US 2026/0030573 A1
(43) Pub. Date: Jan. 29, 2026

(54) AUTOMATED ENGAGEMENT OF TECHNICAL INCIDENT RESPONSE TEAMS USING ARTIFICIAL INTELLIGENCE

(71) Applicant: FMR LLC, Boston, MA (US)

(72) Inventors: Sachin Samuel, Bangalore (IN); Abhishek Simson Canton, Chennai (IN); Vinay Kumar Anumula, Bangalore (IN); Devi Chandrasekaran, Chennai (IN)

(21) Appl. No.: 18/782,344

(22) Filed: Jul. 24, 2024

(51) Int. Cl. G06Q 10/0631; G06F 40/40

(52) U.S. Cl. CPC G06Q 10/063118; G06F 40/40

(57) ABSTRACT

Methods and apparatuses for automated engagement of technical incident response teams using artificial intelligence include a server that receives an incident response request including unstructured computer text comprising a description of an active technical incident and a requested incident response team. The server converts the unstructured computer text into a first vector and compares the first vector to historical vectors generated from incident descriptions contained in historical incident tickets, each historical incident ticket having an assigned incident response team. The server generates a similarity score for each historical incident ticket based upon the comparison between the corresponding historical vector and the first vector and identifies proposed incident response teams using the assigned teams from the historical incident tickets that have a similarity score above a threshold. The server connects to computing devices of team members on the proposed teams to establish a communication channel for the active technical incident.

### TECHNICAL FIELD

This application relates generally to methods and apparatuses, including computer program products, for automated engagement of technical incident response teams using artificial intelligence.

### BACKGROUND

Recently, machine learning (ML) and artificial intelligence (AI) have seen a rise in prominence in a variety of different fields and for a number of specific applications, largely due to advances in computing technology that enables the implementation of advanced algorithms and techniques. One such area is information technology (IT) incident support, where client devices operated by end users of an organization communicate with IT systems of the organization to resolve problems and issues (e.g., downtime, application errors, device failures) within the IT infrastructure. In one example, an end user may utilize his client device (e.g., desktop, laptop, mobile device) to submit an electronic problem ticket, consisting of unstructured computer text that describes the problem, to the organization's incident response management system, where the problem ticket is reviewed to determine personnel with appropriate technical expertise to respond to the incident and contact the team members accordingly.

However, certain major IT incidents may require an immediate and precise response to avoid significant negative impacts on the operation of a production computing environment, which can lead to loss of revenue, customer dissatisfaction, regulatory violations, and other consequences. Traditional IT incident response approaches, such as those described above, often lack the finesse, accuracy, and speed needed to assemble the right IT response teams in a timely manner. This technical gap often leads to delays, inefficiencies, and suboptimal resource allocation during major IT incidents.

In addition, traditional methods of engaging response teams for incidents, particularly in IT and operational environments, introduce several drawbacks that can impact efficiency, effectiveness, and overall response times. Common issues include, but are not limited to:

Manual Dispatching: In many systems, team dispatch is manually decided based on a manager's or dispatcher's knowledge and experience. This can lead to inconsistencies and delays, especially if the decision-maker is unavailable or unfamiliar with the specifics of an incident.

Lack of Real-Time Data: Traditional methods may not effectively leverage real-time data or historical analytics to inform decisions. This can result in suboptimal matching of incidents to response teams, potentially leading to longer resolution times.

Skill Mismatch: Without a robust system to match the specific skills of team members to the requirements of an incident, there can be a significant mismatch. This can decrease the likelihood of first-call resolution and increase the number of escalations and transfers.

Response Time Delays: A study by the Aberdeen Group found that the average response time for companies with standard incident response methods can be significantly higher than those utilizing automated or optimized dispatch systems. Companies using automated systems often see response times reduced by 30% or more.

High Dependency on Human Judgment: Traditional methods often rely heavily on the judgment and experience of individual team members, which can introduce bias and variability in the quality of incident handling.

Scalability Issues: As organizations grow, the volume and complexity of incidents typically increase. Traditional methods, which often rely on fixed processes and limited data inputs, can struggle to scale effectively, leading to increased bottlenecks and response times.

Resource Utilization: Inefficient team engagement can lead to poor utilization of resources, with some teams being overburdened while others are underutilized. Data from IT service management studies indicate that balanced workload distribution can improve team performance by up to 20%.

Cost Implications: Inefficient incident handling can also lead to higher operational costs. According to some studies, companies that optimize their incident response processes can see a reduction in cost per incident of up to 25%.

### SUMMARY

Therefore, what is needed are methods and systems that leverage advanced AI algorithms and techniques to analyze historical IT incident data, predict appropriate team engagements, provide rapid and accurate team recommendations, and automatically connect selected team members on a communication channel to swiftly triage and ameliorate the IT incident. The methods and systems described herein advantageously provide for the following improvements over existing IT incident response systems:

Precision in Recommendations: instead of relying on reactive measures, the methods and systems incorporate historical incident information to proactively suggest the exact response teams that are best equipped to handle a specific incident.

Time Efficiency: As can be appreciated, time is of the essence in IT incident management. The techniques described herein introduce a new level of time efficiency. By providing almost instantaneous team recommendations and connections, the systems and methods expedite the team assembly process, ensuring that the right expertise is on deck promptly to address the incident head-on.

Continuous Learning: Every IT incident is a learning opportunity. The systems and methods described herein evolve with each challenge, continuously learning and adapting based on the latest IT incident data. This ensures that response team prediction and selection becomes increasingly tailored and effective over time.

Seamless Integration: The systems and methods described herein seamlessly integrate into an organization's existing major incident management workflow. With a user-friendly interface, the system becomes an intuitive part of the organization's response strategy, which makes harnessing the power of predictive team engagement as smooth as it is revolutionary.

Data-Driven Decision Making: As mentioned above, traditional systems rely heavily on manual selection based on limited immediate data or subjective assessment, whereas the methods and systems described herein utilize comprehensive historical incident data to inform decision-making, ensuring that recommendations are based on analyzed trends and past outcomes, not just human judgment.

Automated Matching: Manual matching can be slow and prone to errors, often depending on the dispatcher's knowledge and availability. To remedy this problem, the methods and systems described herein automate the process of matching incidents to teams based on a vector analysis of past engagements, reducing human error and speeding up the response time.

Predictive Analytics: existing systems lack forward-looking capabilities and instead these systems are primarily reactive. The methods and systems described herein beneficially incorporate predictive analytics to forecast potential issues and automatically suggest teams with the right expertise before the problem escalates, enhancing proactive incident management.

Scalability and Flexibility: current technology often struggles with scalability issues as organization size and incident complexity grows. In contrast, the technology described herein is designed to scale seamlessly with the organization, capable of handling a large volume of incidents and dynamically adapting to changes in team structure and incident nature.

Real-Time Learning: existing systems employ static decision-making frameworks that do not adapt based on new data or outcomes, whereas the methods and systems described herein feature real-time learning capabilities where the system continuously improves its recommendations based on new incident outcomes and feedback, enhancing accuracy over time.

Dynamic Workloads: traditional methods lead to uneven workload distribution, with some teams being overburdened and others underutilized. The methods and systems described herein optimize resource allocation by ensuring that workload is evenly distributed among teams based on their capacity and specialization, thereby improving overall efficiency and team morale.

Integration with Existing Systems: the technology described herein offers robust integration capabilities with existing IT infrastructure, ensuring that the transition is smooth and does not disrupt current operations.

Customizable Parameters: current systems often operate with a one-size-fits-all approach, which may not be effective for all organizations. The methods and systems described herein advantageously allow for customization of the parameters used for team matching, making it adaptable to specific organizational needs and changing scenarios.

Feedback-Driven Continuous Improvement: traditional technology is typically static, without mechanisms to incorporate direct user feedback into performance enhancements, whereas the technology described herein features a built-in feedback loop where users can provide input on the accuracy and effectiveness of the team recommendations. This feedback is directly utilized to fine-tune the algorithm, enabling continuous improvement and refinement of the model based on real-world usage and outcomes.

The invention, in one aspect, features a system for automated engagement of technical incident response teams using artificial intelligence. The system includes a server computing device having a memory for storing computer-executable instructions and a processor that executes the computer-executable instructions. The server computing device receives an incident response request from a remote computing device, the request including a corpus of unstructured computer text comprising a description of an active technical incident and a requested incident response team. The server computing device converts the corpus of unstructured computer text into a first vector. The server computing device compares the first vector to a plurality of historical vectors generated from incident descriptions contained in historical incident tickets, where each historical incident ticket has an assigned incident response team. The server computing device generates a similarity score for each of the historical incident tickets based upon the comparison between the corresponding historical vector and the first vector. The server computing device identifies one or more proposed incident response teams using the assigned incident response teams from the historical incident tickets that have a similarity score above a threshold value. The server computing device connects the remote computing device to computing devices of team members on one of the proposed incident response teams to establish an incident response communication channel for the active technical incident.

The invention, in another aspect, features a computerized method of automated engagement of technical incident response teams using artificial intelligence. A server computing device receives an incident response request from a remote computing device, the request including a corpus of unstructured computer text comprising a description of an active technical incident and a requested incident response team. The server computing device converts the corpus of unstructured computer text into a first vector. The server computing device compares the first vector to a plurality of historical vectors generated from incident descriptions contained in historical incident tickets, where each historical incident ticket has an assigned incident response team. The server computing device generates a similarity score for each of the historical incident tickets based upon the comparison between the corresponding historical vector and the first vector. The server computing device identifies one or more proposed incident response teams using the assigned incident response teams from the historical incident tickets that have a similarity score above a threshold value. The server computing device connects the remote computing device to computing devices of team members on one of the proposed incident response teams to establish an incident response communication channel for the active technical incident.

Any of the above aspects can include one or more of the following features. In some embodiments, the first vector comprises a multidimensional numeric representation of one or more features of the unstructured computer text. In some embodiments, converting the corpus of unstructured computer text into a first vector comprises one or more of: removing one or more stopwords from the unstructured computer text and removing one or more symbols or digits from the unstructured computer text. In some embodiments, the server computing device compares the first vector to each of the plurality of historical vectors using a similarity measure algorithm. In some embodiments, the similarity measure algorithm is based upon one or more of: cosine similarity, Manhattan distance, Euclidian distance, Jaccard similarity, and dot product similarity. In some embodiments, the server computing device uses an output of the similarity measure algorithm to generate the similarity score for the corresponding historical incident ticket.

In some embodiments, the server computing device selects one of the proposed incident response teams for establishing the incident response communication channel based upon feedback received from the remote computing device. In some embodiments, the server computing device displays the one or more proposed incident response teams on a user interface of the remote computing device and receives a selection of one proposed incident response team from the remote computing device. In some embodiments, the server computing device stores the selection of the proposed incident response team for use in identifying proposed incident response teams for subsequent incident response requests.

In some embodiments, connecting the remote computing device to computing devices of team members on one of the proposed incident response teams comprises opening a conference bridge as the incident response communication channel and automatically connecting the remote computing device and each of the team member computing devices to the conference bridge. In some embodiments, the conference bridge enables the remote computing device and each of the team member computing devices to communicate via audio and/or video.

In some embodiments, connecting the remote computing device to computing devices of team members on one of the proposed incident response teams comprises opening a live chat session as the incident response communication channel and automatically connecting the remote computing device and each of the team member computing devices to the live chat session. In some embodiments, the live chat session enables the remote computing device and each of the team member computing devices to communicate via text messages.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for automated engagement of technical incident response teams using artificial intelligence.

FIG. 2 is a flow diagram of a computerized method of automated engagement of technical incident response teams using artificial intelligence.

FIG. 3 is a diagram of an exemplary user interface generated by web application interface for submission of a new IT incident ticket.

FIG. 4 is a diagram of an exemplary user interface generated by web application interface for display of the list of proposed response teams and/or team members.

FIG. 5 is a diagram of an exemplary user interface generated by web application interface for automatic establishment of a default communication channel.

### DETAILED DESCRIPTION

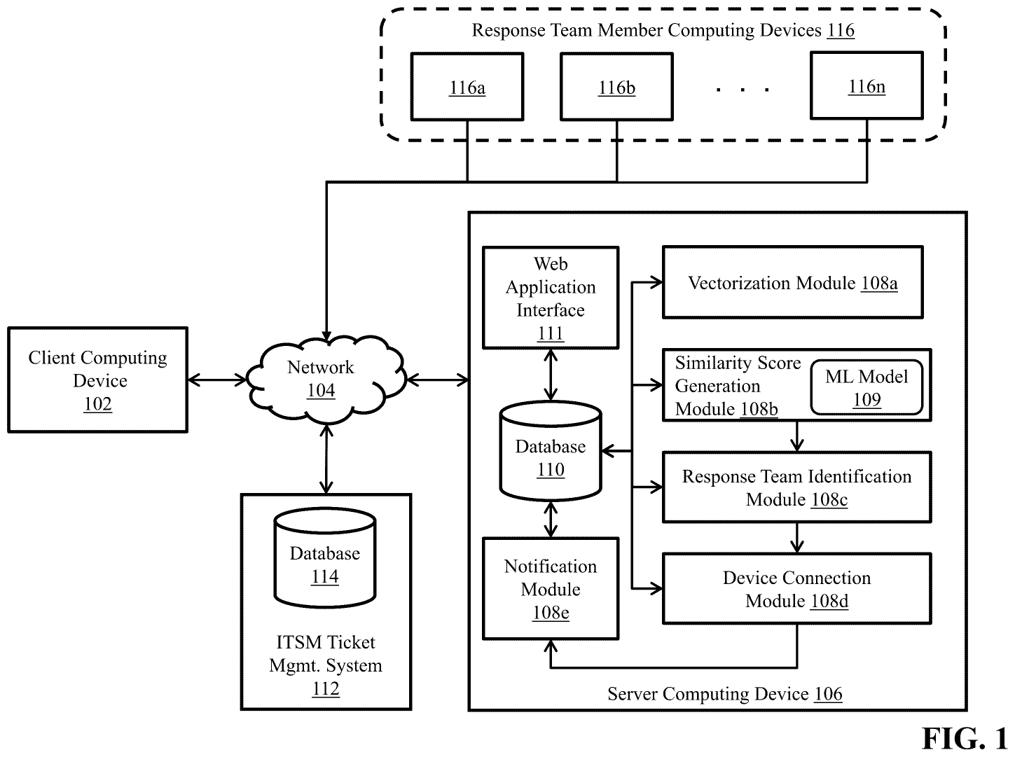

FIG. 1 is a block diagram of system 100 for automated engagement of technical incident response teams using artificial intelligence (AI). System 100 includes client computing device 102, communications network 104, server computing device 106 that includes vectorization module 108a with machine learning (ML) classification model 109, similarity score generation module 108b, response team identification module 108c, device connection module 108d, notification module 108e, database 110, and web application interface 111, information technology service management (ITSM) ticket management computing system 112 coupled to network 104 that includes database 113 for storing, e.g., historical IT incident ticket data, and a plurality of response team member computing devices 116a-116n (collectively, 116).

Client computing device 102 connects to communications network 104 in order to communicate with server computing device 106 and response team member computing devices 116 to provide input and receive output relating to the process of automated engagement of technical incident response teams using AI as described herein. In some embodiments, client computing device 102 includes a display device (e.g., a monitor or screen). For example, client computing device 102 can provide a graphical user interface (GUI) via the display device that presents output resulting from the methods and systems described herein.

Exemplary client computing devices 102 include but are not limited to desktop computers, laptop computers, tablets, mobile devices, smartphones, and internet appliances. It should be appreciated that other types of computing devices capable of connecting to the components of system 100 can be used without departing from the scope of invention. Although FIG. 1 depicts one client computing device 102, it should be appreciated that system 100 can include any number of client computing devices. In some embodiments, each client computing device 102 is associated with a different end user.

Communications network 104 enables client computing device 102, server computing device 106, ITSM ticket management system 112, and response team member computing devices 116 to communicate with each other. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on one or more processors and interact with memory modules of server computing device 106, to receive data from other components of system 100, transmit data to other components of system 100, and perform functions for automated engagement of technical incident response teams using AI as described herein. Server computing device 106 includes several computing modules 108a-108e that execute on one or more processors of server computing device 106. In some embodiments, modules 108a-108e are specialized sets of computer software instructions programmed onto one or more dedicated processors in server computing device 106 and can include specifically designated memory locations and/or registers for executing the specialized computer software instructions.

Although modules 108a-108e are shown in FIG. 1 as executing within the same server computing device 106, in some embodiments the functionality of modules 108a-108e can be distributed among a plurality of server computing devices. As shown in FIG. 1, server computing device 106 enables modules 108a-108e to communicate with each other to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 108a-108e is described in detail throughout the specification.

Similarity score generation module 108b includes machine learning (ML) classification model 109. ML model 109 is a trained machine learning (ML) algorithm that receives input (e.g., multidimensional vectors representing IT incident ticket information) from vectorization module 108a, and processes the input to generate corresponding output, i.e., an identification of one or more predicted or recommended IT incident response teams and/or team members.

Server computing device 106 also includes database 110. Database 110 comprises transient and/or persistent memory for data storage, that is used in conjunction with the process of automated engagement of technical incident response teams using AI as described herein. It should be appreciated that, in some embodiments, database 110 comprises a separate computing device (or in some embodiments, a plurality of separate computing devices) coupled to server computing device 106. Database 110 is configured to receive, generate, and store specific segments of data as described herein. For example, database 110 can comprise one or more relational or non-relational databases configured to store portions of data used by the other components of system 100. Further detail regarding the operation of database 110 is provided below.

Server computing device 106 also includes web application interface 111. Web application interface 111 is a hardware and/or software module that interacts with client computing device 102 (e.g., via browser software) to handle incoming requests (e.g., via HTTP) and to serve related content to the client computing device 102. For example, a user at client computing device 102 can open a browser and type in a URL that points to particular content (such as a webpage for a user of client device 102 to submit a new IT incident ticket) generated by web application interface 111. Client computing device 102 establishes a connection with server computing device 106 via communications network 104 and web application interface 111 provides the requested content via one or more graphical user interface (GUI) screens.

ITSM ticket management computing system 112 is a computing device (or in some embodiments, a set of computing devices) coupled to server computing device 106 via network 104 and is configured to receive, generate, store, and make available specific segments of data relating to the process of automated engagement of technical incident response teams using AI as described herein. In some embodiments, ITSM ticket management computing system 112 hosts and manages historical IT incident ticket information-including but not limited to identification of response teams and/or team members that were assigned to the historical IT incident tickets. ITSM ticket management computing system 112 includes database 114 for storing the historical IT incident ticket information. In some embodiments, database 114 can be integrated with ITSM ticket management computing system 112 or be located on a separate computing device or devices. ITSM ticket management computing system 112 can receive requests for historical IT incident ticket information from server computing device 106 and respond to such requests by providing the associated IT incident ticket information. In some embodiments, ITSM ticket management computing system 112 is configured to store newly created IT incident ticket information (e.g., as submitted by a user of client computing device 102) along with the identified response teams and/or team members determined by modules 108a-108e of server computing device 106 as described herein. As can be appreciated, the newly created IT incident ticket information and assigned team member information can be used to continually re-train ML model 109 to provide the most accurate output (i.e., identification of optimal response teams and/or team members) to subsequent IT incident tickets that are submitted to system 100. An exemplary ITSM ticket management computing platform used by system 112 is ServiceNow™ (available from ServiceNow, Inc.).

Response team member computing devices 116a-116n comprise a plurality of end user computing devices each associated with a different IT incident response team and/or team member. Exemplary response team member computing devices 116 include but are not limited to desktop computers, laptop computers, tablets, mobile devices, smartphones, and internet appliances. It should be appreciated that other types of computing devices capable of connecting to the components of system 100 can be used without departing from the scope of invention. In some embodiments, computing devices 116 include one or more software applications which enable the response team members to communicate with server computing device 106 and/or a user of client computing device 102 in response to a submitted IT incident ticket. For example, upon receiving a notification from notification module 108e, a software application on response team member computing devices 116 can establish a new communication channel, or join an already-existing communication channel, to connect to client computing device 102 and communicate with the user at client computing device 102 to learn more about the IT incident and provide responsive service. In some embodiments, the communication channel can include a voice call (e.g., connecting devices 102 and 116 via a voice-only telephonic conference bridge), a text chat channel (e.g., connecting devices 102 and 116 to exchange instant messages or SMS messages), a video call (e.g., connecting devices 102 and 116 via a videoconference bridge), an email exchange (e.g., connecting devices 102 and 116 via a common email string), or other similar types of electronic communication. It should be appreciated that client computing device 102 can be configured to have the same types of software applications available to the end user of that device 102 for participation in the communication channel. Exemplary applications that can be used by response team member computing devices 116 to communicate with client computing device 102 include, but are not limited to, instant messaging, voice/video conferencing, and collaboration platforms such as Slack™ (available from Slack Technologies, LLC), Zoom™ (available from Zoom Video Communications, Inc.) and Microsoft® Teams™ (available from Microsoft Corp.).

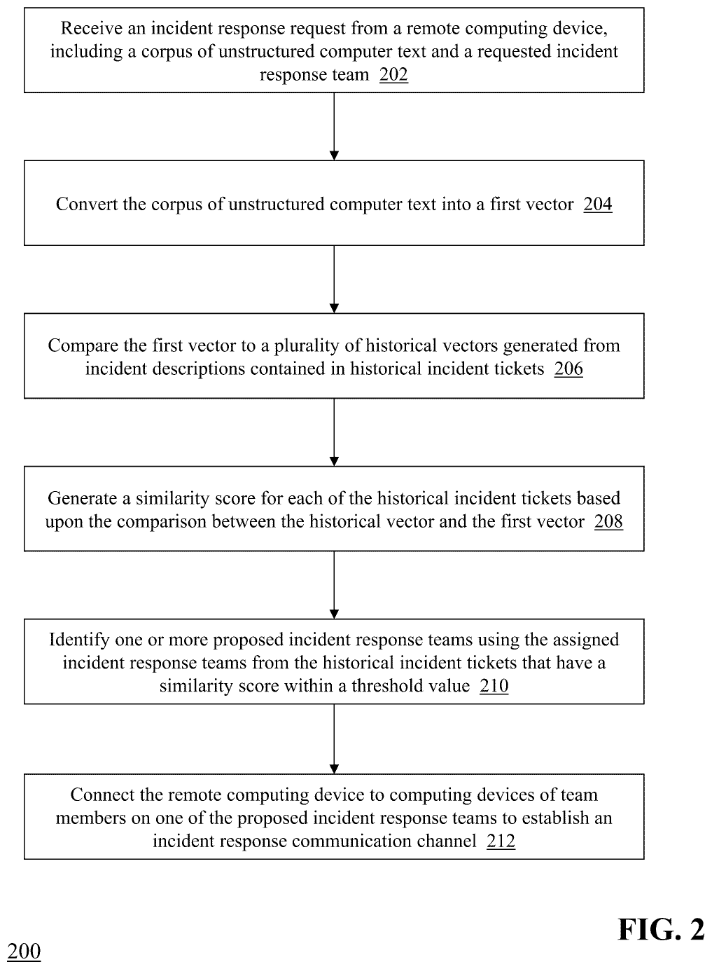

FIG. 2 is a flow diagram of a computerized method 200 of automated engagement of technical incident response teams using AI, using system 100 of FIG. 1. Web application interface 111 receives (step 202) an incident response request from a remote computing device (i.e., client computing device 102) including a corpus of unstructured computer text and a requested incident response team. In one example, a user at client computing device 102 is experiencing an IT-related problem or failure and needs to contact an IT incident response team to resolve the problem. The user at client computing device 102 establishes a connection to web application interface 111 of server computing device 106 (via network 104). For example, the user at client computing device 102 can launch a browser application and establish a connection via HTTPS to a URL associated with web application interface 111 and/or server computing device 106. Web application interface 111 can receive the connection request from client device 102 and provide a user interface (such as a web page) to client computing device 102 that enables the user at device 102 to create a new IT incident ticket.

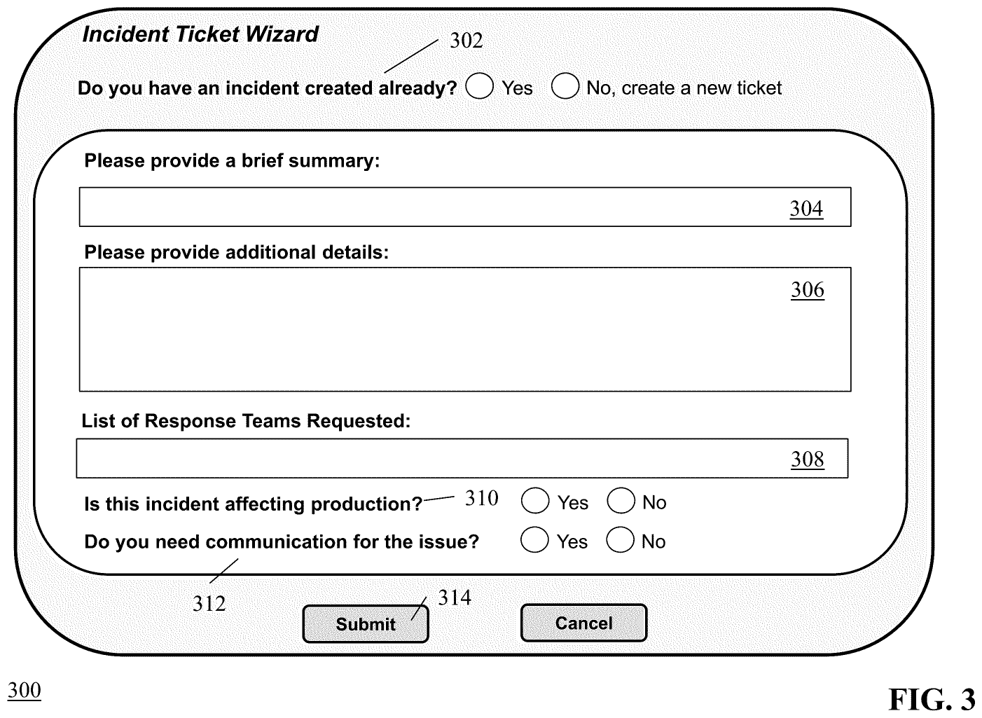

FIG. 3 is a diagram of an exemplary user interface 300 generated by web application interface 111 for submission of a new IT incident ticket. As shown in FIG. 3, user interface 300 includes a plurality of form fields that receive input from the user of client computing device 102. Field 302 enables the user to identify whether they already have a ticket created or need to create a new ticket. Field 304 provides a free-form text field in which the user can provide a brief summary of the IT incident, and field 306 provides another free-form text field in which the user can supplement the brief summary with additional details describing the IT incident. Field 308 is an input area where the user can identify one or more response teams that they require or suggest for responding to the IT incident. Field 310 asks the user whether the IT incident is affecting a production application or computing environment-which may suggest that the incident should have an urgent priority for resolution. Field 312 asks the user whether they need communication for the issue—i.e., whether the system 100 should establish a communication channel with relevant response team members upon submission of the incident ticket. Once the user at client computing device 102 has filled out the form, they can press the Submit button 314 to transmit the incident ticket information as an incident response request to server computing device 106. In some embodiments, web application interface 111 can communicate with ITSM ticket management computing system 112 to generate a new ticket and store the relevant ticket information in database 113.

Vectorization module 108a of server computing device 106 receives the incident ticket information submitted by client computing device 102. Vectorization module 108a converts (step 204) the corpus of unstructured computer text from the incident ticket into a first vector. Module 108a extracts the unstructured computer text from the summary field 304 and the detailed description field 306 in the incident ticket for processing into a multidimensional vector. In some embodiments, module 108a preprocesses the unstructured text before performing the conversion step. For example, module 108a can preprocess the unstructured text to, e.g., filter out stopwords (i.e., common words in a language that are not critical in determining context or meaning of a text corpus); remove spaces, punctuation, and/or special characters like symbols or digits; convert letters to lowercase; and lemmatize words. In some embodiments, module 108a combines the text from the summary field 304 and detailed description field 306 to generate a single corpus of unstructured computer text.

Vectorization module 108a then converts the corpus of unstructured computer text from the incident ticket into a multidimensional feature vector. In some embodiments, module 108a extracts hidden features from the language used in the unstructured text using advanced natural language processing (NLP) algorithmic techniques-such as bag-of-words modeling, term frequency-inverse document frequency (TF-IDF), or other types of embedding generation algorithms.

In one example, module 108a can use a bag-of-words model, where the frequency of each keyword in a set is determined and a weight is assigned to the keyword based upon the frequency. An exemplary technique used by module 108a to convert the text corpus into a vector is the continuous bag-of-words model as described in T. Mikolov et al., “Efficient Estimation of Word Representations in Vector Space,” arXiv: 1301.3781v3 [cs.CL], Sep. 7, 2023, available at arxiv.org/pdf/1301.3781.pdf, which is incorporated herein by reference.

In another example, module 108a can use TF-IDF techniques to generate the multidimensional feature vector. Generally, TF-IDF is a measure of originality of a word by comparing the number of times a word appears in a single corpus of text with the number of corpuses the word appears in.

For a term i in corpus j:

$$TFIDF : {w}_{i , j} = {tf}_{i , j} \times log ( \frac{N}{{df}_{i}} )$$

where tf_{i,j} is the number of occurrences of i in j, dfᵢ is the number of corpuses containing i, and N is the total number of corpuses. Module 108a can use historical incident ticket information from system 112 as additional corpuses of text for the TF-IDF processing described herein. As an example, when comparing the following sentences: “this is sample sentence” and “this sample sentence is to understand tfidf,” N is 2 and the TF-IDF matrix generated by module 108a is shown below in Table 1:

TABLE 1

| | is | sample | sentence | tfidf | this | to | understand |
|---|---|---|---|---|---|---|---|
| 0 | 0.5 | 0.5 | 0.5 | 0 | 0.5 | 0 | 0 |
| 1 | 0.317404 | 0.317404 | 0.317404 | 0.446101 | 0.317404 | 0.446101 | 0.446101 |

In some embodiments, vectorization module 108a can generate a TF-IDF matrix for the unstructured text from historical incident tickets using, e.g., the sklearn.feature_extraction.text.TfidfVectorizer function from the scikit-learn 1.4.2 python library (available from scikit-learn.org). Vectorization module 108a can perform conversion of historical incident ticket text in a batch process, whereby module 108a periodically retrieves the unstructured text from a plurality of historical incident tickets stored in database 113 of ITSM ticket management system 112 and converts the text into vector representations for storage in, e.g., database 110 prior to processing newly submitted incident tickets. By using the batch process, module 108a can improve the speed at which newly submitted incident tickets are processed because module 108a only needs to vectorize the current incident ticket text in real time.

The following is an example showing how vectorization module 108a converts an input ticket into a vector:

A user at client computing device 102 uses web application interface 111 to enter an incident description: “Participant was intermittently experiencing an interruption in service when selecting Benefits for Annual Enrollment.”

Vectorization module 108a cleans the input text (as described above) to generate the following revised corpus of text: “participant intermittently experiencing interruption service selecting benefits annual enrollment”

Vectorization module 108a then converts the cleaned text into the following vector representation (shown in Table 1 below):

TABLE 1

| Term | Vector Representation | |
|---|---|---|
| participant | (0, 1752072) | 0.3333333333333333 |
| intermittently | (0, 1749900) | 0.3333333333333333 |
| experiencing | (0, 1582669) | 0.3333333333333333 |
| interruption | (0, 1289570) | 0.3333333333333333 |
| service | (0, 1289173) | 0.3112233333333333 |
| selecting | (0, 976175) | 0.1124333333333333 |
| benefits | (0, 957606) | 0.3333333333333333 |
| annual | (0, 814984) | 0.3333333333333333 |
| enrollment | (0, 703642) | 0.3333333333333333 |

Once the newly submitted incident ticket text has been vectorized by module 108a, similarity score generation module 108b compares (step 206) the first vector (i.e., the vector generated from the newly submitted ticket) to a plurality of historical multidimensional vectors generated by module 108a from incident description text contained in historical incident tickets stored in database 113. In some embodiments, ML model 109 of module 108b is an embedding model that utilizes a multidimensional vector space to compare the first vector to the historical vectors. For example, ML model 109 can position each of the historical vectors as nodes in the vector space connected via a similarity measure, such as a distance function. ML model 109 then inserts the first vector for the newly submitted incident ticket into the vector space and determines one or more historical vectors that are close to the first vector based upon the similarly measure (e.g., by determining a distance between the first vector and one or more historical vectors based on similarity of features—where vectors with smaller distance measures are closer to each other and thus have a higher similarity of features).

To determine the distance between vectors, ML model 109 can use one or more similarity measure algorithms—such as Euclidian distance, cosine similarity, and Jaccard similarity. In one embodiment, model 109 uses a Euclidian distance measure, as shown in the following exemplary equation where each of the features in the incoming first vector (q1, q2, . . . , qn) is compared to the corresponding features in the historical vectors (p1, p2, . . . , pn):

$$d ( q , p ) = \sqrt{{( {q}_{1} - {p}_{1} )}^{2} + {( {q}_{2} - {p}_{2} )}^{2} + … + {( {q}_{n} - {p}_{n} )}^{2}}$$

In another embodiment, the module 110 uses a cosine similarity measure, as shown in the following exemplary equation, where the incoming first vector (a) is compared to the historical vector (b):

$$cos θ = \frac{\vec{a} \cdot \vec{b}}{‖ \vec{a} ‖ ‖ \vec{b} ‖}$$

Similarity score generation module 108b determines one or more historical incident vectors in the vector space that are in proximity to the first vector based upon at least one of the distance measures described above. These historical context vectors can be thought of as the ‘neighbors’ or ‘neighborhood’ for the first vector in the vector space—the distance measure acts as a cutoff to define which neighboring historical vectors are similar enough to the first vector to be useful for determining candidate incident response team members for the newly submitted incident ticket. In some embodiments, to decide the optimal distance cutoff, module 108b can apply a minimum neighborhood approach, where module 108b chooses a distance cutoff at which the distance measure from the first vector to the neighboring vectors is at or below a defined threshold value. It should be appreciated that other distance cutoffs can be employed within the scope of invention.

The following is an example of similarity score generation as performed by similarity score generation module 108b:

Input group name: “WEBSERVER SUPPORT TEAM”

Input issue description: “Participant was intermittently experiencing an interruption in service when selecting Benefits for Annual Enrollment.”

Output:

TABLE 2

| Candidate Incident | Similarity |
|---|---|
| Response Team | Score |
| Web Server App Support | 0.65 |
| Technology Service Desk | 0.40 |
| Technology Operations Team | 0.37 |
| ABC App Support | 0.35 |
| Enterprise Web Team | 0.35 |
| Storage Team | 0.23 |
| Network Team | 0.20 |
| Cloud Support Team | 0.18 |
| Call Center Support Team | 0.18 |
| Credit Card Team | 0.16 |

Upon identifying one or more historical vectors that are within the desired distance from the first vector, similarity score generation module 108b generates (step 208) a similarity score for each of the historical incident tickets based upon the distance measure. In some embodiments, module 108b uses the distance measure as the similarity score. For example, module 108b can determine that three historical incident vectors are within a threshold distance value (e.g., 0.5) of the first vector in the multidimensional vector space:
Historical Vector A=0.35 distance measure;
Historical Vector B=0.44 distance measure; and
Historical Vector C=0.49 distance measure.

Module 108b can then assign the distance measure values as the similarity scores for each of the historical vectors. Other methodologies for generating a similarity score can be used by module 108b, including weighting the distance measure based upon a variety of factors-such as a timestamp associated with the historical incident ticket (e.g., more recent tickets may be afforded greater weight) or a resolution status associated with the historical incident ticket (e.g., tickets that were resolved more quickly or more accurately may be afforded greater weight). Also, the first vector for the newly submitted incident ticket is now incorporated into the vector space of ML model 109. As described below, once the response team members are identified and assigned to the ticket, the corresponding vector representation can be updated by module 108a and re-introduced into the vector space-such that ML model 109 is continually updated with additional incident ticket details to provide for a more accurate similarly measure for subsequent incident tickets.

As mentioned previously, each historical incident ticket is associated with one or more incident response team members who were assigned to investigate and resolve the incident. The identification of incident response team members is stored as part of the historical incident ticket in database 113. Once the similarity scores are generated, response team identification module 108c can use the historical team member information along with the similarity scores to identify (step 210) proposed incident response teams and/or team members for the newly submitted incident ticket. In some embodiments, response team identification module 108c identifies proposed incident response teams using the assigned incident response teams from the historical incident tickets that have a similarity score within a threshold value. For example, module 108c receives an identification of historical vectors (e.g., a list of historical incident ticket IDs) and associated similarity scores from module 108b. Response team identification module 108c retrieves the corresponding historical incident ticket details from database 113 of ITSM ticket management system 112, including the teams and/or team members assigned to each of the historical tickets. Module 108c then generates a list of proposed teams and/or team members using the historical information—for example, module 108c can determine whether there is any overlap in team members between the respective historical tickets and aggregate the information.

In some embodiments, response team identification module 108c is configured to compare the list of proposed teams to the identification of teams and/or members provided by the user of client computing device 102 during the ticket submission process (as contained in field 308 of user interface 300). In one example, module 108c can determine that one or more teams identified in field 308 (which user of client computing device 102 required as part of the response) are represented in the list of proposed teams generated by module 108c. Module 108c can then identify a certain number of proposed teams (e.g., top 5, top 10) to be included in the list based upon similarity score. In another example, module 108c can determine that one or more teams identified in field 308 are not represented in the list of proposed teams generated by module 108c. Module 108c can then modify the list of proposed teams to include the teams that were provided by the user of client computing device 102—resulting in an aggregated list of proposed teams including both top teams according to similarity score and teams identified by the user of client computing device 102.

In some embodiments, module 108c is configured to automatically select one of the teams and/or team members from the proposed list for responding to the incident ticket. For example, module 108c can identify the team that is associated with the historical incident ticket that is the most similar to the newly submitted ticket (e.g., based upon similarity score). Module 108c can then automatically select the identified team and assign that team to the newly submitted ticket.

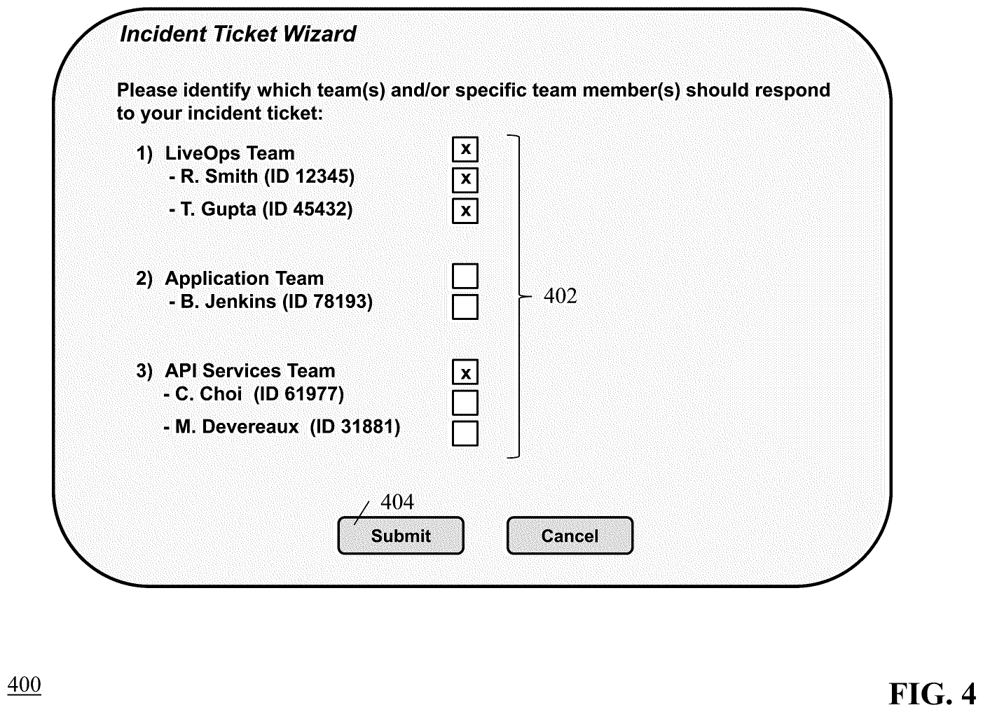

In some embodiments, system 100 is configured to capture input on the list of proposed response teams from the user of client computing device 102 prior to assigning a response team to the newly submitted ticket. For example, a particular user may choose teams or team members different from, or in addition to, those being proposed by module 106c. Response team identification module 108c communicates the list of proposed teams to web application interface 111, which generates a user interface including the list for display on client computing device 102. FIG. 4 is a diagram of an exemplary user interface 400 generated by web application interface 111 for display of the list of proposed response teams and/or team members. As shown in FIG. 4, user interface 400 includes the list 402 of proposed response teams generated by module 108c. Next to each team and/or team member in the list is a checkbox that the user of client computing device 102 can select to indicate that they want the corresponding team or member to be part of the response team. Once the user has completed the form, they can interact with the Submit button 404 to provide the input to response team identification module 108c.

Module 108c can provide the list of proposed teams and/or the selected response teams (based on user input, automatic selection, or both) to similarity score generation module 108b as part of a feedback loop. For example, similarity score generation module 108b can associate the proposed teams and/or selected teams with the newly submitted incident ticket in database 113, and then incorporate the team assignment into the vector representation in the vector space of ML model 109. This feedback loop enhances the accuracy and robustness of ML model 109 by ensuring that the most up-to-date team assignments are reflected in the model 109 for evaluation of subsequently submitted incident tickets.

Device connection module 108d connects (step 212) the remote computing device (i.e., client device 102) to computing devices 116 of team members on one of the proposed incident response teams to establish an incident response communication channel. For example, once the response team is identified and assigned to the ticket as described above, module 108d determines contact information associated with each of the assigned team members. In some embodiments, module 108d retrieves identifying contact information (such as phone number, email address, or collaboration system username) for each team member from database 110. In some embodiments, the contact information for each team member is arranged according to a preference of the team member—e.g., one team member may prefer to be contacted via phone call, while another may prefer to be contacted via text message. Module 108d then determines a type of communication channel to establish based upon, e.g., the contact information and/or other business rules or considerations. For example, if the newly submitted ticket is determined to have an urgent priority (e.g., based upon the user's selection of “Yes” in field 310 of user interface 300), module 108d can select a telephone conference bridge as the type of communication channel to use, so that immediate communication and collaboration can be facilitated. In another example, if the newly submitted ticket is determined to have a low priority, module 108d can select an email exchange as the type of communication channel to use.

In some embodiments, module 108d can select the type of communication channel based upon the incident ticket submitted by the user of client computing device 102. For example, if the user answers “Yes” in field 312 of user interface 300—indicating that they need communication with the response team for the issue-module 108d can automatically select a certain type of communication channel (e.g., a telephone bridge or an instant messaging session).

Once the type of communication channel is determined, device connection module 108d uses the relevant contact information for the user of client computing device 102 and the identified team members at devices 116a-116n to establish the incident response communication channel. In the example of a telephone call, device connection module 108d opens a conference bridge and initiates an outbound voice call to an identifier (e.g., phone number, IP address) associated with the user of client device 102 and each of the team members at devices 116a-116n. Once each of the devices 102 and 116a-116n indicates successful receipt of the outbound voice call, device connection module 108d joins each of the respective devices 102, 116a-116n to the conference bridge so that the participants can discuss technical and operation details of the IT incident along with strategies for addressing the incident.

In some embodiments, notification module 108e is configured to transmit a separate incident notification to each of the identified response team members at devices 116a-116n in conjunction with establishing the incident response communication channel as described above. For example, when the selected communication channel is a telephone conference, notification module 108e can transmit a message (e.g., text, IM, app alert, email) via a separate communication channel to the identified team members so that they are aware that an incident occurred, and they have been assigned to respond. In some embodiments, the message can include a link (e.g., URL, conference phone number) for the team member to access the communication channel selected for the incident.

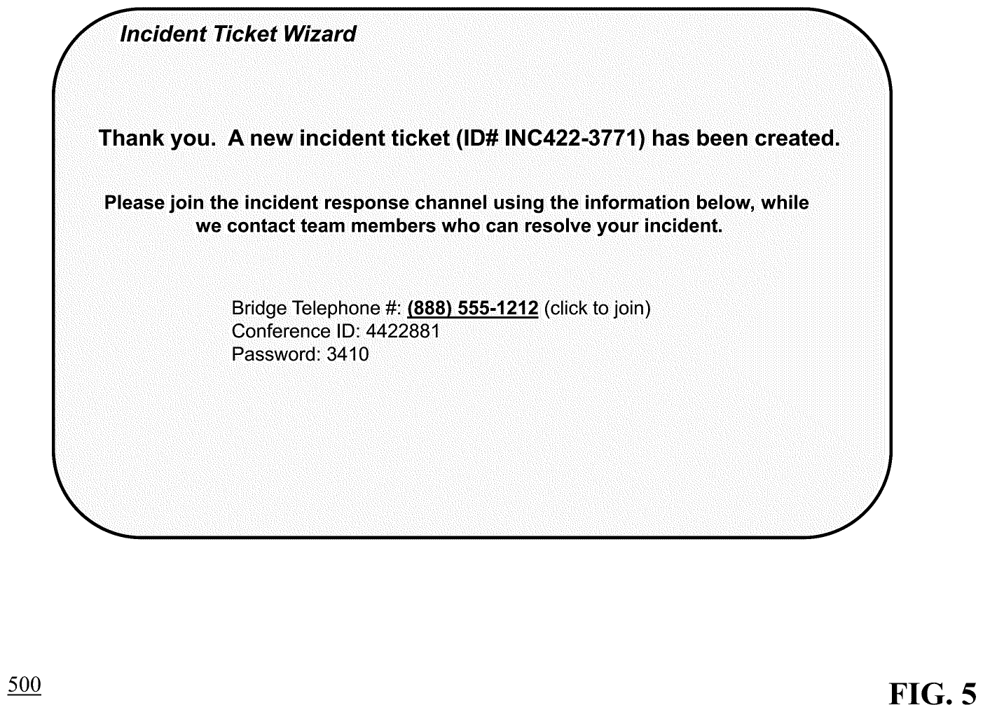

In some embodiments, system 100 is configured to establish the incident response communication channel in parallel with modules 108a-108e processing the newly submitted ticket and identifying an appropriate incident response team as described above. For example, as soon as the user of client computing device 102 submits a new IT incident ticket, device connection module 108d can establish a default communication channel and connect the user at client computing device 102 to the communication channel while system 100 in parallel identifies and contacts response team members. FIG. 5 is a diagram of an exemplary user interface 500 generated by web application interface 111 for automatic establishment of a default communication channel. As shown in FIG. 5, user interface 500 includes an incident ticket ID for the new ticket as well as connection information for the user at client computing device 102 to use in joining the default communication channel. Using this approach, the user can immediately join the communication channel and wait as response team members are each identified and connected. As can be appreciated, user interface 500 can also be displayed to the user at client computing device 102 after selection of team members in FIG. 4 and determination of an appropriate communication channel as described above.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN)), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for automated engagement of technical incident response teams using artificial intelligence, the system comprising a server computing device having a memory for storing computer-executable instructions and a processor that executes the computer-executable instructions to:
receive an incident response request from a remote computing device, the request including a corpus of unstructured computer text comprising a description of an active technical incident and a requested incident response team;
convert the corpus of unstructured computer text into a first vector;
compare the first vector to a plurality of historical vectors generated from incident descriptions contained in historical incident tickets, wherein each historical incident ticket has an assigned incident response team;
generate a similarity score for each of the historical incident tickets based upon the comparison between the corresponding historical vector and the first vector;
identify one or more proposed incident response teams using the assigned incident response teams from the historical incident tickets that have a similarity score above a threshold value; and
connect the remote computing device to computing devices of team members on one of the proposed incident response teams to establish an incident response communication channel for the active technical incident.

2. The system of claim 1, wherein the first vector comprises a multidimensional numeric representation of one or more features of the unstructured computer text.

3. The system of claim 2, wherein converting the corpus of unstructured computer text into a first vector comprises one or more of: removing one or more stopwords from the unstructured computer text and removing one or more symbols or digits from the unstructured computer text.

4. The system of claim 1, wherein the server computing device compares the first vector to each of the plurality of historical vectors using a similarity measure algorithm.

5. The system of claim 4, wherein the similarity measure algorithm is based upon one or more of: cosine similarity, Manhattan distance, Euclidian distance, Jaccard similarity, and dot product similarity.

6. The system of claim 5, wherein the server computing device uses an output of the similarity measure algorithm to generate the similarity score for the corresponding historical incident ticket.

7. The system of claim 1, wherein the server computing device selects one of the proposed incident response teams for establishing the incident response communication channel based upon feedback received from the remote computing device.

8. The system of claim 7, wherein the server computing device displays the one or more proposed incident response teams on a user interface of the remote computing device and receives a selection of one proposed incident response team from the remote computing device.

9. The system of claim 8, wherein the server computing device stores the selection of the proposed incident response team for use in identifying proposed incident response teams for subsequent incident response requests.

10. The system of claim 1, wherein connecting the remote computing device to computing devices of team members on one of the proposed incident response teams comprises:
opening a conference bridge as the incident response communication channel; and
automatically connecting the remote computing device and each of the team member computing devices to the conference bridge.

11. The system of claim 10, wherein the conference bridge enables the remote computing device and each of the team member computing devices to communicate via audio and/or video.

12. The system of claim 1, wherein connecting the remote computing device to computing devices of team members on one of the proposed incident response teams comprises:
opening a live chat session as the incident response communication channel; and
automatically connecting the remote computing device and each of the team member computing devices to the live chat session.

13. The system of claim 12, wherein the live chat session enables the remote computing device and each of the team member computing devices to communicate via text messages.

14. A computerized method of automated engagement of technical incident response teams using artificial intelligence, the method comprising:
receiving, by a server computing device, an incident response request from a remote computing device, the request including a corpus of unstructured computer text comprising a description of an active technical incident and a requested incident response team;
converting, by the server computing device, the corpus of unstructured computer text into a first vector;
comparing, by the server computing device, the first vector to a plurality of historical vectors generated from incident descriptions contained in historical incident tickets, wherein each historical incident ticket has an assigned incident response team;
generating, by the server computing device, a similarity score for each of the historical incident tickets based upon the comparison between the corresponding historical vector and the first vector;
identifying, by the server computing device, one or more proposed incident response teams using the assigned incident response teams from the historical incident tickets that have a similarity score above a threshold value; and
connecting, by the server computing device, the remote computing device to computing devices of team members on one of the proposed incident response teams to establish an incident response communication channel for the active technical incident.

15. The method of claim 13, wherein the first vector comprises a multidimensional numeric representation of one or more features of the unstructured computer text.

16. The method of claim 15, wherein converting the corpus of unstructured computer text into a first vector comprises one or more of: removing one or more stopwords from the unstructured computer text, and removing one or more symbols or digits from the unstructured computer text.

17. The method of claim 14, wherein the server computing device compares the first vector to each of the plurality of historical vectors using a similarity measure algorithm.

18. The method of claim 17, wherein the similarity measure algorithm is based upon one or more of: cosine similarity, Manhattan distance, Euclidian distance, Jaccard similarity, and dot product similarity.

19. The method of claim 18, wherein the server computing device uses an output of the similarity measure algorithm to generate the similarity score for the corresponding historical incident ticket.

20. The method of claim 14, wherein the server computing device selects one of the proposed incident response teams for establishing the incident response communication channel based upon feedback received from the remote computing device.

21. The method of claim 20, wherein the server computing device displays the one or more proposed incident response teams on a user interface of the remote computing device and receives a selection of one proposed incident response team from the remote computing device.

22. The method of claim 21, wherein the server computing device stores the selection of the proposed incident response team for use in identifying proposed incident response teams for subsequent incident response requests.

23. The method of claim 14, wherein connecting the remote computing device to computing devices of team members on one of the proposed incident response teams comprises:
opening a conference bridge as the incident response communication channel; and
automatically connecting the remote computing device and each of the team member computing devices to the conference bridge.

24. The method of claim 23, wherein the conference bridge enables the remote computing device and each of the team member computing devices to communicate via audio and/or video.

25. The method of claim 14, wherein connecting the remote computing device to computing devices of team members on one of the proposed incident response teams comprises:
opening a live chat session as the incident response communication channel; and
automatically connecting the remote computing device and each of the team member computing devices to the live chat session.

26. The method of claim 25, wherein the live chat session enables the remote computing device and each of the team member computing devices to communicate via text messages.
